(19) United States
(12) Patent Application Publication
(10) Pub. No.: US 2016/0039046 A1
(43) Pub. Date: Feb. 11, 2016

(54) Method of Beam-Type Joining

(71) Applicant: Scansonic MI GmbH, Berlin (DE)

(72) Inventor: Christoph Franz, Berlin (DE)

(21) Appl. No.: 14/452,544

(22) Filed: Aug. 6, 2014

(51) Int. Cl. B23K 26/03; B23K 26/24

(52) U.S. Cl. CPC B23K 26/034; B23K 26/24

(57) ABSTRACT

The invention relates to a method for joining workpieces by a processing beam, wherein a first workpiece and a second workpiece are interconnected at a joint by means of the processing beam under heating and wherein thermal images are being captured by means of a thermal imaging camera; each of the thermal images comprises a first thermal imaging section, which characterizes the temperature distribution of the first workpiece, and a second thermal imaging section, which characterizes the temperature distribution of the second workpiece.

### CROSS REFERENCE TO RELATED APPLICATIONS

This application claims the benefit under 35 USC 119 of German Applications No. DE 102013108481.8 filed on Aug. 6, 2013; and No. DE 102013112244.2 filed on Nov. 7, 2013; all applications are incorporated by reference herein in their entirety.

### BACKGROUND

The invention relates to a method for joining workpieces by means of a high-energy processing beam, by means of which a reliable seam tracking and a detection of joining flaws are made possible.

During thermal joining of metal sheets or other workpieces by means of a processing beam (e. g. a laser beam), the number and the dimensions of junction flaws must be kept as small as possible in order to ensure a high quality junction. Among other things, this necessitates an exact positioning of the processing beam relative to the workpieces to be joined together, wherein remaining junction flaws can be detected by means of different flaw detection methods and corrected, for example, by post-processing.

In terms of flaw detection, there are different approaches to assessing the quality of joining seams, e.g. weld seams, wherein the assessment of the joint quality is usually carried out after the joining process. The quality of weld seams can, for example, be assessed based on the measurement of their geometry, wherein surface structures, pores and seam dropouts are detected. It is disadvantageous, however, that the external assessment does not allow a clear conclusion to be drawn on the quality of the junction.

In addition, the joint quality of for example weld seams can be assessed by exploiting the principle of thermography. Here, the radiation pattern of workpieces as approximately described by Planck's law is measured and characterized temporally and/or spatially with respect to its intensity distribution; the intensity of infrared radiation emitted from a position on the surface of the workpiece is interpreted as a measure of the temperature at this position. The temporal and/or spatial intensity distribution of the energy radiated from the workpiece provides information on the quality of the connection. It is known, for example, to assess by means of thermography the quality of weld seams by briefly heating the welded components and evaluating the quality of the connection via the heat dissipation at the joining point. This exploits the fact that in the presence of a complete, flawless connection the material cools faster than in the presence of a defective connection.

Further methods for flaw detection in laser welding processes on overlap joints are described for example in DE 103 38 062 A1, DE 10 2007 024 789 B3, DE 10 2009 052 529 A1 and DE 10 2011 078 276 B3, wherein an observation of two interconnected plates in the form of an overlap joint occurs from the plane side of the overlap joint. Hence, these methods are suitable only for validating overlap joints, wherein—as only one of the two joining members is directly detected—only indirect conclusions on the joint quality are possible.

### SUMMARY

The invention relates to a method for joining workpieces by a processing beam, wherein a first workpiece and a second workpiece are interconnected at a joint by means of the processing beam under heating and wherein thermal images are being captured by means of a thermal imaging camera; each of the thermal images comprises a first thermal imaging section, which characterizes the temperature distribution of the first workpiece, and a second thermal imaging section, which characterizes the temperature distribution of the second workpiece.

### DETAILED DESCRIPTION

The object of the invention is to provide a method for the beam joining of workpieces, with which in an uncomplicated manner the appearance of joining flaws can be minimized and remaining joining flaws can be identified reliably.

According to the invention this object is achieved with a method according to claim 1; practical embodiments of the invention are in the dependent claims.

A device for thermal joining, such as by soldering or welding, of workpieces by means of a high-energy processing beam, e.g. a laser beam, is referred to as “joining device” in the following. The joining device is formed for joining a first of the workpieces to be joined with a second of the workpieces to be joined at a joint formed by these two workpieces while these are heated, wherein the workpieces can be available for example in the form of sheets. The workpieces can for example be clamped by means of a damping device of the joining device while the joint is formed, wherein the damping device comprises opposed clamping elements for engaging at the work pieces. The processing beam may be positioned, for example, by means of a beam guiding device of the joining device on the workpieces; the beam guiding device may comprise, among others, one or more deflector elements (e.g. mirrors) for guiding the processing beam.

The joining device also has a thermal imaging camera by means of which thermal images of a portion of the joint heated by the processing beam when joining can be captured. The thermal imaging camera is arranged and formed such that each of the thermal images captured by it comprises a first thermal image portion, which characterizes the temperature distribution of the first workpiece in the captured joint portion, and a second thermal imaging section, which characterizes the temperature distribution of the second workpiece in the captured joint portion. The camera may for example be arranged and formed such that the detection range captured by it by thermography completely covers the area lying between the clamping elements of the damping device. Thus, by means of a single observation system (the thermal imaging camera) one or more images of two or more workpieces (e.g. sheets) are produced at a joining point, wherein the plates considered can be detected together in a single image.

By means of the thermal imaging camera spatially resolved temperature-dependent quantities can be generated, which characterize the temperatures at different positions of the joining members. The temperature present at a particular position is characterized by the intensity of the infrared radiation emitted from this position; said radiation intensity can be detected by means of a thermal imaging camera, for example in the form of a voltage value, a gray level or a color value, wherein each pixel or sensor element of the thermal imaging camera corresponds to such a temperature-dependent value. Different temperature values can thus be represented in the thermal images e.g. by different radiation intensity values, voltage values, gray levels or color values. The thermal images may in particular be present in the form of intensity distributions or rather intensity maps; the intensity at a pixel may be given by, for example, the associated infrared radiation intensity, the associated voltage value or the associated gray level brightness, and may be proportional to the temperature at the associated workpiece position. The intensity values can be converted into absolute temperature values, but this is not absolutely necessary. Thus, by means of the thermal imaging camera the intensity distribution of the thermal radiation emitted from the workpieces is measured temporally and/or spatially resolved.

As the thermal imaging camera simultaneously captures both workpieces to be joined together in a single image, the heat input generated by the processing beam into both workpieces can be detected simultaneously, hence enabling a simultaneous and direct detection of the geometry of the joint region and the molten pool, respectively, in both workpieces. Thus, joining flaws can be identified reliably and the quality of the joining seam produced can be detected with high accuracy. The simultaneous detection of the geometry of the joint region and the molten pool, respectively, in both joining partners also allows conclusions to be drawn on the positioning of the processing beam relative to the workpieces; in determining a faulty positioning of the beam a position correction can be performed. Positioning and beam guidance of the processing beam is thus possible based on the captured thermal images, i.e., the thermal image data can also be used for seam tracking. By means of the thermal images a correct beam positioning is possible, hence the number of joining flaws can be kept small. As the thermal images can be used both for seam tracking and flaw detection, no separate facilities must be provided for both of these functionalities, hence the number of components required can be kept low. As the thermal image capturing is carried out by utilizing the heat input generated by the processing beam, the joining device also needs no separate heat source, illumination device or any other power source for the observation of the joining point.

The invention thus relates to the joining of two or more workpieces (e.g. sheets) by high-energy radiation, wherein, for example, two sheets are welded together at their edges (especially at the front side or as a square butt weld in the immediate vicinity of one or more sheet edges). The invention allows the detection of the joint quality of sheets welded together in such a manner; the fact is used that when welding by means of a laser beam or other processing beam, the beam itself introduces heat and the heat flow is measured in the immediate vicinity of the melt produced by the beam. Thus, the thermal behavior of two or more joining members can be detected simultaneously, whereby e.g. the heat flow between the joining members can be measured. As a result, an online or rather real-time quality assessment of the joint produced is possible. In addition, gaps occurring between the workpieces to be joined may be identified immediately (and not indirectly via the sign of the heat or temperature characteristic at the top surface of one of the two joining members).

The measurement of the temperature characteristic of the joining point can be performed during the joining process or immediately after joining. It may for example be provided that the joining device is moved (e.g., by means of a mechanical feed device) in a feed direction along the joint relative to the workpieces to be joined, whereby also the impinging position of the processing beam is moved on the workpieces in the feed direction. The joining device may thereby be formed in such a manner (e.g., by means of appropriate placement and orientation of the thermal imaging camera) that the range captured by the thermal imaging camera includes the impinging position of the processing beam (in this case the temperature characteristic is detected during joining). However, the joining device may also be formed such that the portion captured by the thermal camera with respect to the feed direction is located behind the impinging position of the processing beam and hence does not include the impinging position of the processing beam (in this case, the temperature characteristic is detected after the joining).

The joining device is preferably formed for forming front seams and fillet seams on a front side of an overlap joint; the observation by means of the thermal imaging camera is also preferably done from the front side of the overlap joint (i.e., the thermal imaging camera is preferably arranged on the front side at a distance from the front surface).

The processing beam is guided (e.g., by means of the beam guiding device) along a processing beam path running towards the joint. It may be provided that the thermal imaging camera is arranged so that its observation beam path runs completely separated from the processing beam path (so-called lateral camera arrangement and observation geometry, respectively).

According to one embodiment, the thermal imaging camera is arranged so that the observation beam path of the thermal imaging camera at least partially coincides with the processing beam path of the processing beam (so-called coaxial camera arrangement and observation geometry, respectively). Thus, a space-effective, space-saving design of the joining device is made possible.

The infrared radiation captured by the thermal imaging camera may be decoupled from the processing beam path, for example by means of a deflection mirror of the beam guiding device, which is transparent for the infrared wavelength range captured by the thermal imaging camera and reflective for the wavelength range of a laser beam acting as a processing beam. It can also be provided that the observation beam is directed via an adjustable scanning mirror (which is reflective for the infrared wavelength range captured by the thermal imaging camera) of the beam guide means, whereby larger work areas can be detected by thermography.

According to one embodiment, the thermal imaging camera is arranged and formed such that the joint portion can be captured along the entire width of the joint (formed by the first and the second workpieces). The thermal imaging camera can, for example, be formed and arranged so that the maximum clamping width coverable by the damping elements is captured. This, for example, ensures that when damping sheets by means of the damping device, the entire width of the joint can always be captured by thermography by the thermal imaging camera. As the entire width of the joint is detected by thermography, i.e. in each thermal image, both the first and the second workpiece or sheet are detected along its entire thickness, all of the heat input effected by the processing beam can be considered in the seam tracking and/or error detection.

The joining device can be formed for evaluation of thermal images in terms of joining flaws, i.e., for identifying joining flaws and assessing the quality of the joint based on the thermal images. Alternatively or additionally, the joining device may be formed for evaluating the thermal images with respect to the positioning of the processing beam and for positioning the processing beam based on the result of the evaluation. The positioning of the processing beam may be changed, for example by adjusting the deflector of the beam guiding device or by repositioning the beam guiding device.

The evaluation of a thermal image can be done, for example, by comparing the first thermal image portion with the second thermal image portion, wherein e.g. an asymmetry in the characteristic temperature distributions of these both thermal image portions (with respect to the course of the joint) can be assessed as an incorrect positioning of the processing beam and/or as a joining flaw. Alternatively, the evaluation of a thermal image can be done by comparing the thermal image with a predetermined desired thermal image, wherein e.g. a deviation of the actually present thermal image from the desired thermal image can be assessed as an incorrect positioning of the processing beam and/or as a joining flaw.

It was surprisingly found that the heat transfer or rather temperature drop is so sharp at a workpiece edge (e.g., a sheet edge) that e.g. the position of an outer edge of the joint is clearly detectable in the thermal images, so that a seam tracking can be realized on the basis of such a detected workpiece edge. Thus, a separate seam tracking device (e.g. in the form of a laser triangulation device) can be dispensed with, for example by forming the joining device such that the processing beam already through damping by the damping device is positioned, to a good approximation, precisely on the workpieces, and the exact positioning is regulated via the desired thermal image (e.g. by comparing the actually present thermal image with a predetermined desired thermal image and varying the positioning of the processing beam such that the actual thermal image is brought into alignment with the desired thermal image).

The first and the second workpiece are connected at the joint to form a joining seam extending along the joint. The joint has a longitudinal axis extending along the joint and the joint seam, respectively, and a transversal axis extending transversely to the joint and the joint seam, respectively. For the evaluation of the thermal images it may be provided to measure only the temperature curve or an intensity profile representing the temperature curve along lines, wherein those lines preferably extend transversely and/or longitudinally to the joint and the joint seam, respectively.

According to one embodiment, the joining device is formed such that from the infrared images at one or more longitudinal positions of the joint a transverse intensity profile, which characterizes the temperature curve along a direction or line extending transverse to the direction of the joint, can be detected by it and the evaluation of the thermal images is carried out with the involvement of the detected transverse intensity profiles. Such a transverse intensity profile can for example be given directly by a transverse temperature curve; however, it can also be provided that the temperature values are represented by temperature-dependent intensity values (see above).

The joining device may in particular be formed such that in each transverse intensity profile those mutual outermost positions, at which the transverse intensity profile falls below a predetermined threshold value, are assessed by it as lateral boundary positions, which limit the area heated by the processing beam with respect to the direction extending transverse to the joint, and the evaluation of the thermal images is performed with the involvement of the detected boundary positions.

The joining device may be formed, for example, such that the distance between the mutual lateral boundary positions is detected as thermal track width by it and it is considered as joining flaw or incorrect positioning of the processing beam when the thermal track width at one or more longitudinal positions of the joint is smaller than a predetermined track width minimum value (the track width minimum value can be specified as a function of the longitudinal position).

Alternatively or additionally, the joining device may be formed such that in each transverse intensity profile, a transversal position is assessed by it as an edge position of one of the workpieces to be joined, when at this transversal position the amount of change (for example in the form of the differential or in the form of an intensity jump) of the transverse intensity profile is at least as high as a predetermined minimum value. The knowledge of the edge position can, for example, be used for seam tracking, wherein the positioning of the processing beam is performed with the involvement of the detected edge position(s).

The evaluation of the thermal images may in particular be performed with the involvement of the mutual boundary positions relative to the mutual edge positions; it can be assessed, for example, as joining flaw and/or incorrect positioning of the processing beam when the two boundary positions are not (within predetermined limits) arranged symmetrically or centrally between the two edge positions or do not coincide with the same.

According to an embodiment, the joining device is formed such that from the infrared images at one or more transverse positions of the joint a longitudinal intensity profile, which characterizes the temperature gradient along a line extending longitudinally to the joint line, can be detected by it and the evaluation of the thermal images is performed with the involvement of the detected longitudinal intensity profiles. Such a longitudinal intensity profile may be given, for example, by a longitudinal temperature curve; however, it can also be provided that the temperature values are represented by temperature-dependent intensity values (see above).

It can be provided, for example, that a first longitudinal intensity profile is detected at a transverse position located on the first workpiece and a second longitudinal intensity profile is detected at a transverse position located on the second workpiece. The evaluation of the thermal images occurs by means of comparison between the first longitudinal intensity profile with the second longitudinal intensity profile; it can be assessed, for example, as joining flaw and/or incorrect positioning of the processing beam when the first and second longitudinal intensity profile do not coincide (within predetermined limits).

Moreover, the joining device may be formed to determine the length of the current joining seam portion based on the longitudinal intensity profiles; for example, the distance between a longitudinal position, at which the longitudinal intensity profile exceeds a first threshold, and a longitudinal position, at which the longitudinal intensity profile is below a second threshold, can be considered as the length of the current joint seam portion.

According to the invention, a method of joining, e.g. soldering or welding, of workpieces by means of a processing beam, such as a laser beam is provided, wherein the method can in particular be provided for operating a joining device according to one of the above described embodiments. The joining method corresponds to the operation described with reference to the joining device, so that the joining method is explained only briefly below and with respect to the embodiments of the joining method, reference is hereby made to the corresponding explanations regarding the joining device.

The method comprises joining a first of the workpieces to be joined with a second of the workpieces to be joined in a joint by means of a processing beam under heating and capturing one or more thermal images of a joint portion heated by the processing beam; each of the thermal images comprises a first thermal image portion, which characterizes the temperature distribution of the first workpiece, and a second thermal image portion, which characterizes the temperature distribution of the second workpiece. Thus, according to the method in particular, the two (or more) workpieces which are present, for example, as sheets, are detected simultaneously by thermography; for example, the heat flow between the two workpieces is directly detectable.

The processing beam is guided along a processing beam path towards the joint. The thermal images are captured using a thermal imaging camera that can be arranged, e.g. forming a coaxial observation geometry, such that the observation beam path of the thermal imaging camera at least partially extends along the processing beam path of the processing beam. The capturing of thermal images can be done in particular such that each of the thermal images captures the joint portion along the entire width (i.e. dimension along the direction transverse to the joint direction) of the joint impact.

The method may further comprise an evaluation of the thermal images; the evaluation can be performed with respect to the detection of joint flaws and/or with regard to the detection of the positioning of the processing beam. In the latter case, the method may further comprise the positioning of the processing beam based on the result of the image evaluation. Thus, by means of the invention, in particular a method for detecting flaws and a method for seam tracking are provided based on the evaluation of the thermal images, wherein these two methods may also be carried out independently of the joining method.

The evaluation of the images may for example be performed as described above with respect to the joining device. Thus, the image evaluation can be performed, for example, by detecting and evaluating one or more transverse intensity profiles, wherein for example the boundary positions that define the heated section and the edge positions that define the joint can be determined from the transverse intensity profiles, wherein these quantities in turn can be used for error detection and/or for quality assessment. Furthermore, the image evaluation can, for example, comprise the detection and evaluation of one or more longitudinal intensity profiles, as described above.

### BRIEF DESCRIPTION OF THE DRAWINGS

The invention will be described hereinafter on the basis of exemplary embodiments with reference to the accompanying figures, wherein like or similar features are provided with like reference signs; in the drawings are shown:

FIG. 1 a joining device with a thermal imaging camera during joining;

FIG. 2A-2C thermal images of a joint;

FIG. 2D a line drawing of the thermal images according to FIGS. 2A-2C;

FIG. 3 a transverse intensity profile characterizing the temperature curve;

4 a longitudinal intensity profile characterizing the temperature curve;

FIG. 5 different welding configurations on front seams;

FIG. 6 different welding configurations on fillet seams;

FIG. 7 different detection geometries; and

FIG. 8 various possible welding configurations on a three-plate connection.

### DETAILED DESCRIPTION OF THE PREFERRED EMBODIMENT

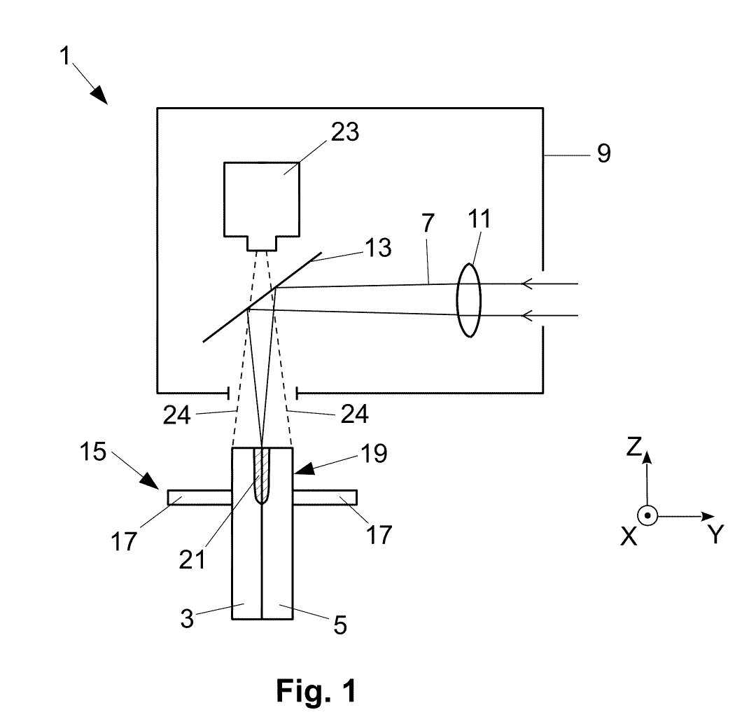

FIG. 1 illustrates schematically a joining device 1 according to an embodiment during joining of two workpieces in the form of sheets 3, 5 by means of a processing beam in the form of a laser beam 7, wherein a front side weld on an overlap joint is illustrated as a two-sheet connection. The joining device 1 comprises a beam guiding device 9 for the positioning of the laser beam 7; the beam guiding device 9 comprises, inter alia, a focusing unit 11 and a deflection unit in the form of a deflection mirror 13. The joining device 1 also comprises a traveling clamping device 15 having on opposite sides two rotating traveling clamping elements 17 between which the two sheets 3, 5 are clamped to form a joint formed as an overlap joint 19. The sheets are as an example galvanized steel sheets having a sheet thickness of 1.2 mm.

The beam guiding device 9 is formed and arranged such that during joining, the laser beam 7 is directed by it from the front side of the overlap joint 19 towards the front surface of the joint, so that the laser beam 7 impinges on the two sheets 3, 5 at the joint of the same and the two sheets 3, 5 are welded with each other on the front side at the impinging position of the laser beam 7 to form a weld seam 21. During joining, the joining device 1 is moved along the x direction as feed direction.

According to FIG. 1, the joint plane or parting plane of the overlap joint 19 extends parallel to the xz plane of the xyz coordinate system shown in the figures; the longitudinal direction of the overlap joint 19 and the weld seam 21 extend parallel to the x direction and the direction extending transversely to the overlap joint 19 and the weld seam 21 extends parallel to the y direction.

For carrying out the method of the invention, the joining device 1 comprises a thermal imaging camera 23. The thermal imaging camera 23 is arranged and formed such that a portion of the joint 19 is captured by it by thermography along the entire width (i.e., extension along the y direction) of the joint 19 (illustrated in FIG. 1 by the dashed lines 24). Each of the thermal images captured by the thermal imaging camera 23 thus covers a portion of the first sheet 3 and a portion of the second sheet 5 in the area of the current joining point; the detection range 24 of the sheets 3, 5 captured by the thermal imaging camera 23 comprises the impinging position, at which the laser beam 7 impinges on the joint 19. Thus, each of the thermal images has a first thermal imaging section, which characterizes the temperature distribution of the first sheet 3, and a second thermal imaging section, which characterizes the temperature distribution of the second sheet 5.

Thermal imaging camera 23 is arranged on the side of the deflection mirror 13 that is facing away from the beam path of the laser beam 7; the maximum clamping width achievable with the clamping elements 17 can be detected by it by thermography. The deflection mirror 13 is a wavelength-selective partially transparent mirror, which is transparent for the wavelength range of the infrared radiation used by the thermal imaging camera 23 and reflective for the wavelength of the laser beam 7. The thermal imaging camera 23 is arranged such that the observation beam path of the thermal imaging camera 23 coincides with the beam path of the laser beam 7 in the area between the deflection mirror 13 and the joint 19. Thus, a coaxial observation geometry is present, wherein the observation (in the range mentioned) is performed coaxially with the optical axis of the laser radiation.

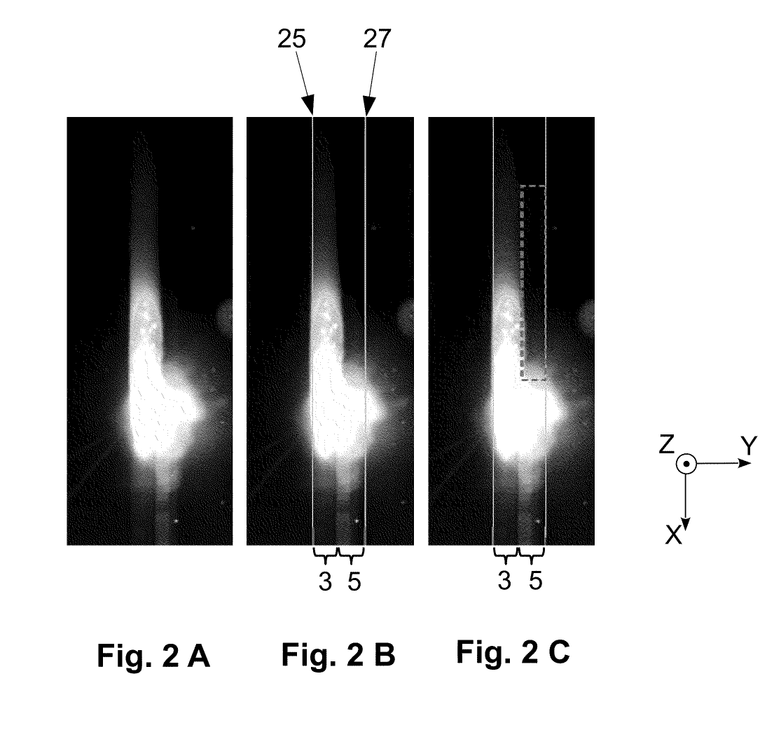

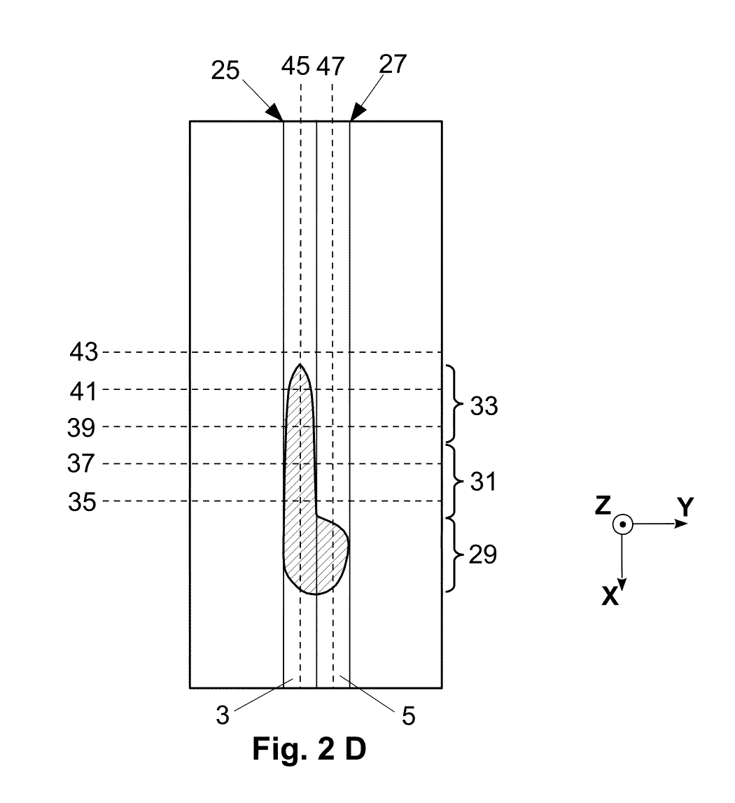

FIGS. 2A, 2B and 2C show a thermal image captured as a gray level image during welding, wherein higher temperatures are represented by a lighter gray level. Clearly visible is the bright glow in the lower half of the image, where the laser beam 7 (here scanned with an oscillation frequency of about 1 kHz) impinges on the front side of the overlap joint 19. Further up in the figures, the liquid phase of the metal, which all in all appears a bit darker in the figures and comprises highlights typical for the melt on the surface (troughs and crests), joins. In the top half of each image, the emission characteristic induced by the high temperature can be recognized, which reflects the cooling behavior.

FIG. 2A shows the captured thermal image. In FIG. 2B, the two outer sheet edges of the overlap joint 19 were drawn manually afterwards as lines 25, 27. As seen in the figures on the basis of the pronounced asymmetry of the thermal image (in terms of the joint), the two-sheet application exhibits a poor junction. The reason for this lies in an incorrect positioning of the laser spot, because of which only the first sheet 3 (arranged on the left of the two plates 3, 5) was effectively welded into. In the thermal image, this manifests itself in the fact that above the laser beam impinging position (represented by the brightest area), the melt can only be seen in the left of the two sheets. As seen in the thermal image, almost no heat flows into the second plate 5 (arranged on the right), so that the thermal image remains dark in this area, which is characterized in FIG. 2C by the rectangle marked with dashed lines.

In FIG. 2D, the thermal image shown in FIGS. 2A to 2C is schematically represented as a line drawing; the positions of the two sheets 3, 5 are shown together with the joint outer edges 25, 27. The contour of the area appearing bright in FIGS. 2A to 2C (which characterizes the high-temperature heated region) is shown hatched in FIG. 2D. The region heated by the laser beam 7 comprises a section 29, on which the laser beam 9 impinges and which therefore exhibits the highest temperature. Adjacent to the section 29, the heated region sequentially comprises a section 31, in which the metal of the right sheet 3 is melted, and a section 33, in which the metal of the right sheet 3 exhibits an elevated temperature below the melting temperature. The temperature decreases in the direction from the laser impinging section 29 through the molten pool section 31 to the cooling section 33; the temperature distribution shown allows conclusions to the cooling behavior and the flow of heat.

It can be seen in the thermal images illustrated in FIGS. 2A to 2D that the cooling behavior allows conclusions to be drawn regarding a merely unilateral junction. For detecting and evaluating the positioning of the beam and the junction characteristics, the joining device 1 is formed such that from the thermal images several intensity profiles along lines transverse and longitudinal to the joint seam 21 are detected by it; such an intensity profile characterizes the temperature curve along the respective line (wherein higher intensities correspond to higher temperatures).

The joining device 1, as an example, is formed such that from the thermal images captured by the camera 23 a transverse intensity profile, which characterizes the temperature distribution, is detected by it along each of five lines 35, 37, 39, 41, 43 (which are arranged at different longitudinal positions of the joint 19) running transverse to the joint 19 and the joining seam 22 (and thus running along the y direction). The captured thermal images are evaluated by the joining device 1 with the involvement of these transverse intensity profiles as follows.

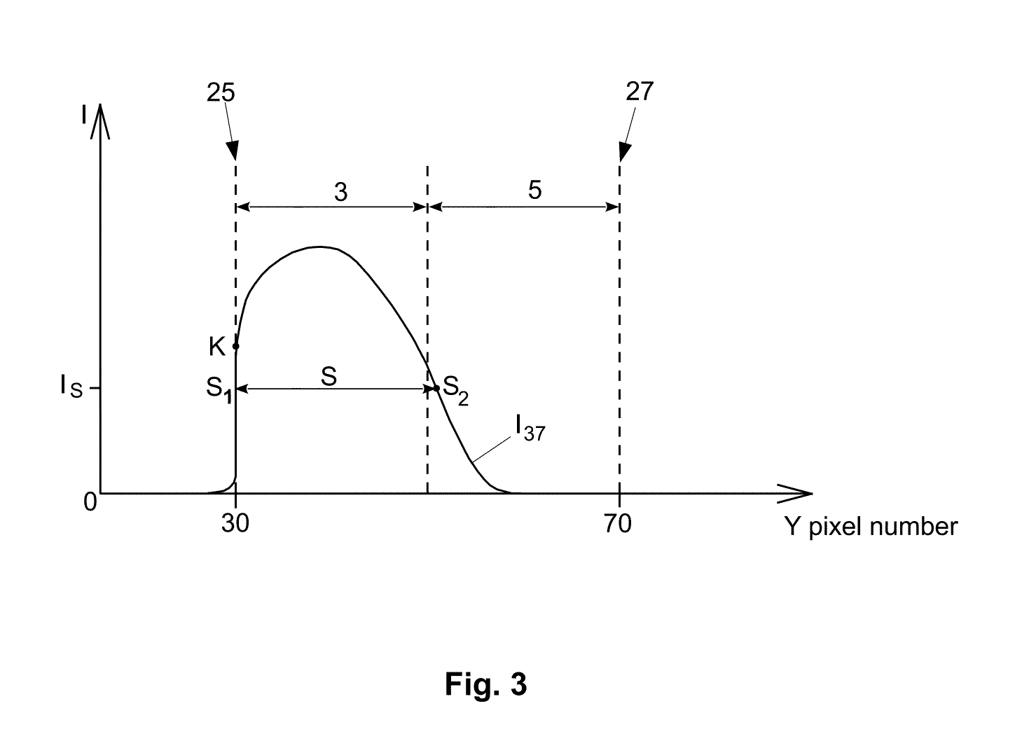

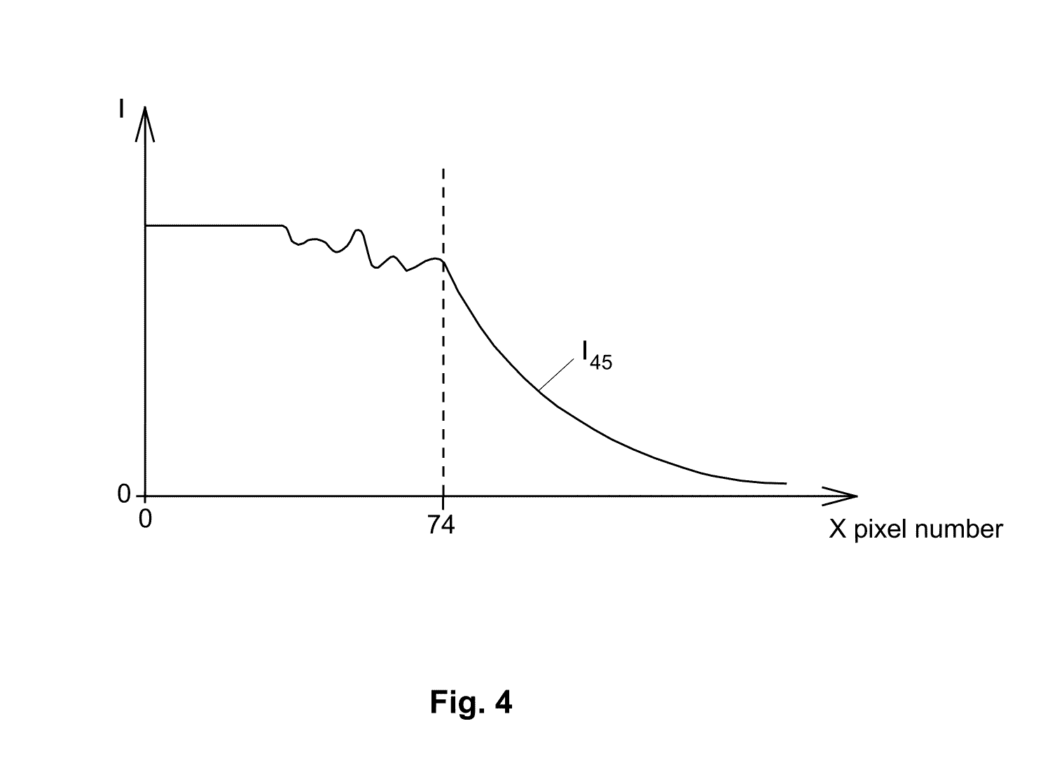

FIG. 3 illustrates exemplary the transverse intensity profile I₃₇ along the transverse line 37; on the abscissa is plotted the pixel number of the sensor of the thermal imaging camera 23 (along the y direction) and on the ordinate is plotted the intensity (wherein a higher temperature corresponds to a higher intensity). Although the intensity profile in FIG. 3 is continuously pictured, in practice the discrete pixels of the sensor of the thermal imaging camera 23 deliver a discrete intensity distribution, but which can be analogously processed to a continuous intensity distribution or be converted in such by means of a smoothing prior to processing. Within a transverse line, the intensity values are smoothed over a width of 17 pixels (width of ROI); hence false detections caused by splashes can be avoided. In FIG. 3, the position of the sheets 3, 5 and the joint outer edges 25, 27 are illustrated. The intensity profile shown exhibits a strong intensity jump at the position K, which corresponds to the joint outer edge 25 formed by the left sheet 3. In addition, the intensity profile drops significantly in the region of the second sheet 5 (with a good connection, the right sheet 5 should actually have been heated in this region).

The joining device 1 is formed such that in the transverse intensity profile I₃₇ the mutual outermost edge positions S₁, S₂, at which the transverse intensity profile is below a predetermined threshold value I_{S}, are assessed by it as lateral boundary positions, which limit the area heated by the laser beam 7 with respect to the direction extending transverse to the direction of the joint 19. The distance between the two boundary positions S₁, S₂ is detected at the longitudinal position 37 as thermal track width S of the heated region.

Further, a transversal position at which the amount of change of the transverse intensity profile I₃₇ is at least as large as a predetermined minimum change value is assessed by the joint device 1 as an edge position K of one of the sheets 3, 5. The change of the intensity profile can be given, for example, by an intensity jump between two pixels in the case of discrete intensity profile and, for example, by the derivative in the case of a continuous intensity profile. It can be provided, for example, to assess a transversal position as edge position when the intensity profile exhibits an intensity jump of more than three levels of intensity at the corresponding position. In the present case, the left boundary position S₁ coincides with the left edge position K.

In an analogous manner, the boundary positions, track widths and edge positions at the other longitudinal positions 35, 39, 41 and 43 are determined; the threshold value and the minimum change value may have different values for different longitudinal positions. With the evaluation being performed at different positions, the robustness of the method is increased. The robustness can be further increased by an automatic adjustment of the parameters to the overall brightness, the homogeneity of the image and the overall contrast.

As a result of the measurement, the evaluation unit coupled with the thermal imaging camera 23 hands the evaluation measurement pairs on. For each of the transverse lines 35 to 43, this results in the x value of the respective line, the y value of the left threshold, and the y-value of the right threshold. Subsequently, it is calculated whether all y values are valid (plausibility check via variance). From the valid values, the track width is calculated. It is known from the application and the copy ratio that the track width S along the y direction corresponding to the sheet packet thickness must amount to at least a predetermined number of pixels; in the example illustrated, the desired track width is 40 pixels. However, since the actually present track width S is less than 30 pixels, this is assessed as the presence of an incorrect positioning of the laser beam 7 and as a connection flaw, wherein the error status “too narrow track width” is output. In addition, the positioning of the laser beam 7 may be corrected by the joining device 1, such that the track width corresponds to the defined track width.

Further, along two lines 45, 47 that extend longitudinally to the joint 19 (and thus along the x direction) and are located at different transverse positions of the joint 19, a longitudinal intensity profile, which characterizes the temperature distribution along the respective line, is detected by the joining device 1. Using the previously detected track width boundary positions and edge positions, the longitudinal line 45 is positioned centrally on the first sheet 3 and the longitudinal line 47 is positioned centrally on the second sheet 5.

FIG. 4 illustrates exemplarily the longitudinal intensity profile I₄₅ along the longitudinal line 45; on the abscissa, the pixel number of the sensor of the thermal imaging camera 23 (along the x-direction) is plotted and on the ordinate the intensity is plotted. The longitudinal intensity profile I₄₅ shown in FIG. 4 is typical of a weld seam: The melt extends up to pixel No. 74; subsequently the intensity profile correlates with the temperature curve. On the right sheet 5, this course is not discernible due to the incorrect positioning of the laser beam 7. Once pores or ejection of melt occur (not shown here), the temperature curve is unsteady and is automatically recognized in the evaluation algorithm of the joining device 1. Depending on the user setting of the tolerated length of seam flaws, the error message “incomplete seam” and the value of the error length is output.

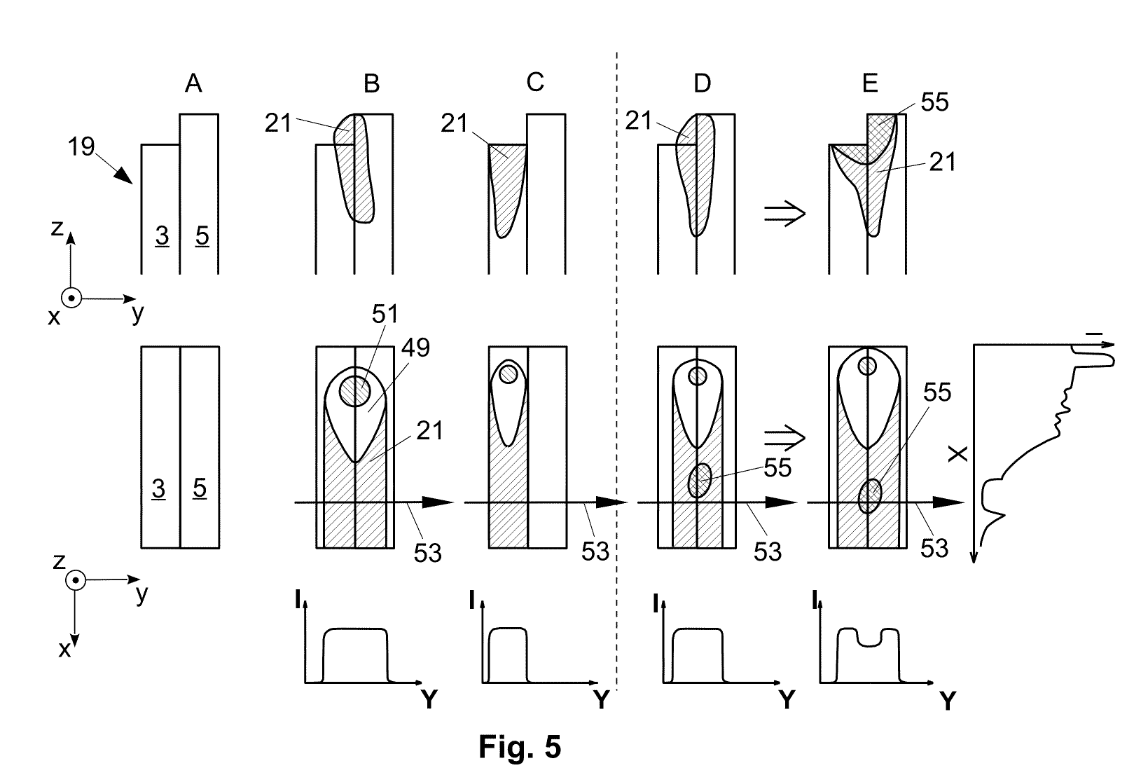

FIG. 5 illustrates schematically different welding configurations on front seams by frontal welding and associated intensity profiles along the associated transverse lines and longitudinal lines. Each of the sub-figures A through E of FIG. 5 shows in the upper part a cross section and in the middle part a plan view of the two sheets 3, 5, arranged to the joint 19; the area 21 characterizes the weld, the area 49 characterizes the melt pool, and the area 51 characterizes the impinging area of the laser beam 7 (these areas are exemplary shown in sub-figure B). In the lower part of each sub-figure, an intensity profile characterizing the temperature curve is shown along the transverse line 53 illustrated in the corresponding top view; to the right of the plan view of sub-figure E is also shown the intensity profile along the center direction extending longitudinal to the joint 19. Sub-FIG. 5A shows the cross section and the plan view of the weld configuration prior to welding. Sub-FIG. 5B shows a flawless weld seam 21, which can be recognized in that the intensity profile has a high value over (essentially) the whole package width. Sub-FIG. 5C shows a faulty seam 21 due to incorrect positioning of the laser beam 7, which can be recognized in that the intensity profile has too low values on the second sheet 5 arranged on the right. Sub-FIGS. 5D and 5E show a faulty weld seam 21, which is due to an ejection of weld material 55; this flaw is not detected in the configuration under sub-FIG. 5D, since the ejection of weld material 55 is not detected by the transverse line 53, whereas said flaw is detected in the configuration under sub-FIG. 5E, since the ejection of weld material is detected by the transverse line 53 as well as the centrally extending longitudinal line and becomes visible in the corresponding intensity profiles by a local decrease in intensity.

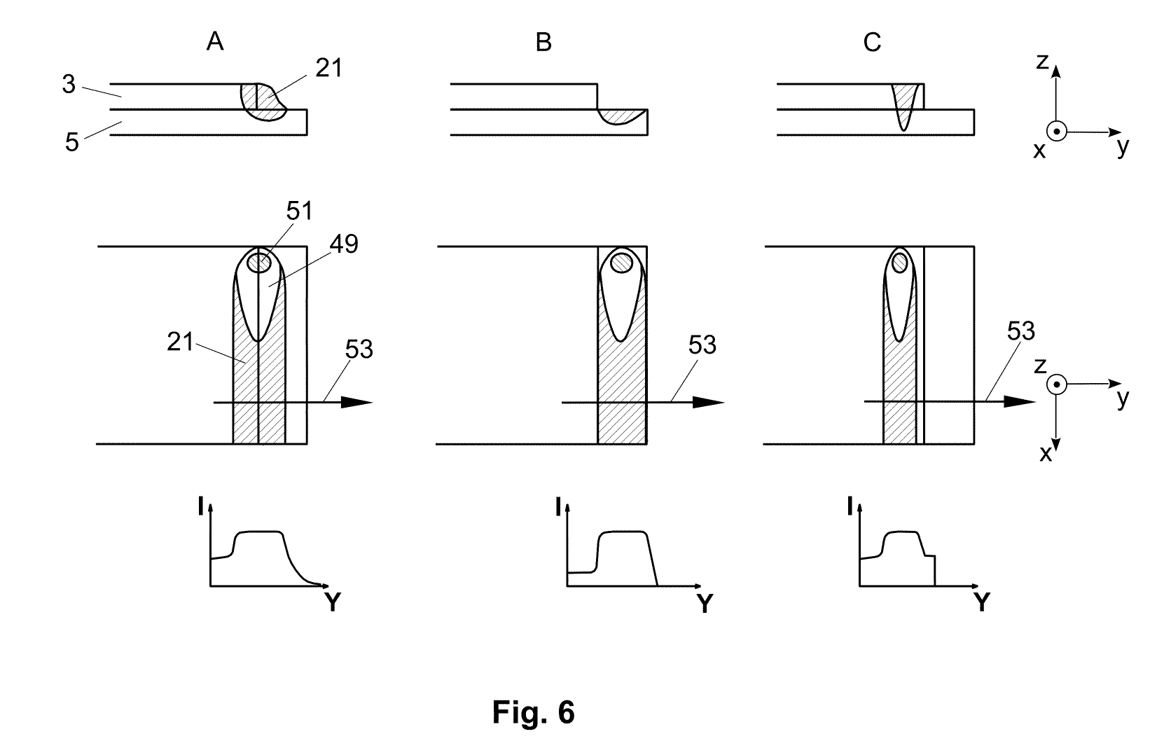

FIG. 6 illustrates schematically different welding configurations on fillet seams and associated intensity profiles along selected transverse lines 53; the explanations to FIG. 5 apply mutatis mutandis. Sub-FIG. 6A illustrates the case of a flawless fillet weld. Sub-FIG. 6B illustrates the case of a faulty fillet weld; the weld is positioned too far outside on the outer second sheet 5, which can be recognized in that the intensity profile is located too far to the right and exhibits on its left flank too steep an increase in intensity. Sub-FIG. 6C illustrates the case of a faulty fillet seam; the weld is positioned too far inward on the inner first sheet 3, which can be recognized in that the intensity profile is located too far to the left and exhibits on its right flank too steep a drop in intensity. The latter two cases can be detected by the joining device, for example by being taken as incorrect positioning of the laser beam 7 and/or as joining flaw, when the amount of change of the intensity profile (e.g., represented by an intensity jump or by the derivative of the intensity profile) at a position is above a predetermined threshold value.

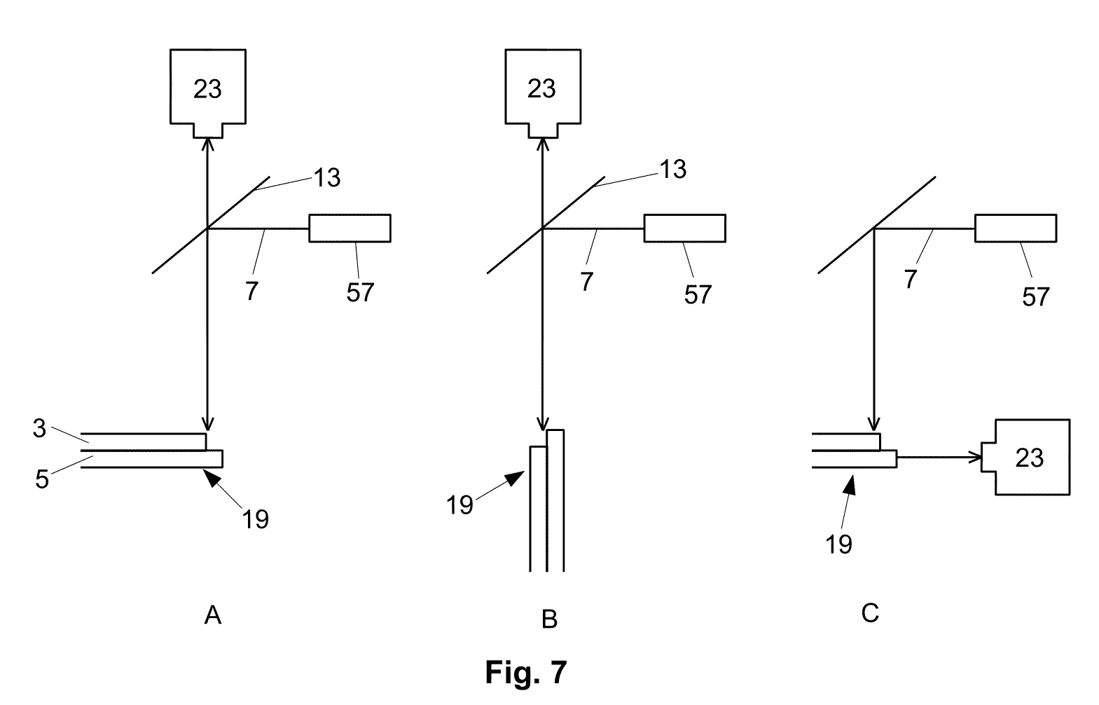

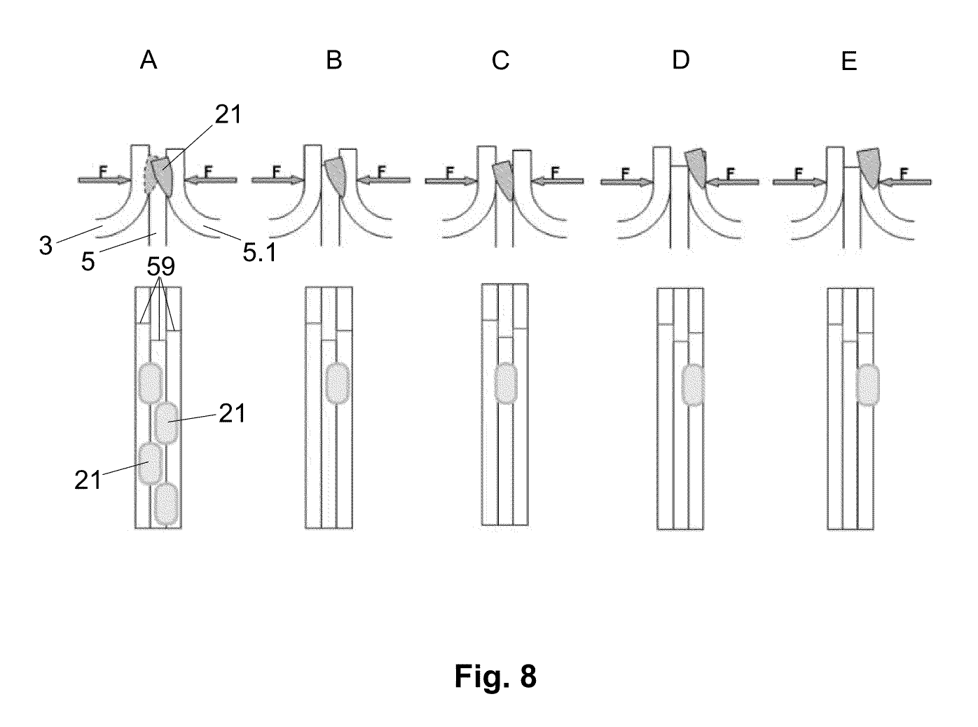

FIG. 7 illustrates schematically different possible arrangements of the thermal imaging camera 23 relative to the joint 19 with the two sheets 3, 5 and the laser 57, which emits the laser beam 7. Sub-FIGS. 7A and 7B respectively show a coaxial observation geometry with a wavelength-selective partially transmissive deflection mirror 13, which is transparent to the wavelength range of the infrared radiation used by the thermal imaging camera 23 and reflective to the wavelength of the laser beam 7; sub-FIG. 7A illustrates a geometry for generating a fillet seam and sub-FIG. 7B illustrates a geometry for producing a front seam. The deflection mirror 13 may be either fixed or movable. Sub-FIG. 7C illustrates an alternative geometry for producing a fillet seam and for detection by thermography thereof; the thermal imaging camera 23 looks sideways at the fillet seam (it can also be provided that the thermal imaging camera 23 looks sideways at a front seam). However, it can also be provided to arrange the thermal imaging camera 23 in a different geometry, so that the angle between the processing beam path of the laser beam 7 and the observation beam path of the thermal imaging camera 23 is a different angle than in the sub-FIGS. 7A-7C, so long as both sheets 3, 5 are detected at the same time by the thermal imaging camera 23.

FIG. 8 illustrates schematically different quality flaws resulting from incorrect positioning of the laser beam 7 during the joining of three plates 3, 5, 5.1; the weld seam sections 21 of a stitch seam are represented by gray areas and the clamping force applied by the clamping elements 17 is represented by the arrows F. Each of the sub-FIGS. 8A to 8E shows in the upper part a cross section and in the lower part a plan view of the sheet package; in the plan view are also shown triangulation lines 59 that characterize the height position of the front surfaces of the respective sheet. The sub-FIGS. 8A and 8B show a flawless weld. Sub-FIG. 8C shows a joining flaw due to a central weld 21. Sub-FIG. 8D illustrates a joining flaw due to a weld 21 being arranged too far in one of the outer sheets. Sub-FIG. 8E illustrates a joining flaw due to bulging, which in this area is cumbersome particularly when attaching a rubber gasket.

In terms of quality assurance, the joining device 1 may be adapted based on the above evaluation criteria, in particular to detect the following criteria: (a) determining whether a seam is present at all, (b) determining whether the seam is present in a defined position to the middle position between the two or more joining partners, (c) determining whether the predetermined welding depth has been reached, (d) determining whether the predetermined length of the weld seam has been reached, and/or (e) determining whether the sheet connections exhibit a pre-defined or predetermined gap in the specified limits.

### LIST OF REFERENCE NUMERALS

1 joining device

3, 5, 5.1 sheet

7 processing beam/laser beam

9 beam guiding device

11 focusing unit/focusing lens

13 deflection unit/deflection mirror

15 clamping device

17 clamping element

19 joint

21 joint seam/weld seam

23 thermal imaging camera

24 detection range of the thermal imaging camera

25, 27 outer sheet edges/edges of the joint

29 laser impinging section

31 molten pool section

33 cooling section

35-43 transverse line for intensity profile measurement

45, 47 longitudinal line for intensity profile measurement

49 molten pool section

51 impingement surface of the laser beam

53 transverse line for intensity profile

55 ejection of weld material

57 laser

59 triangulation line

I₃₇ transverse intensity profile/transverse temperature curve

I₄₅ longitudinal intensity profile/longitudinal temperature curve

I intensity

I_{S} threshold intensity

K edge position

S₁, S₂ boundary position of the heated section and the thermal trace

S track width

1. A method for joining workpieces by means of a processing beam, comprising the joining of a first of the workpieces to be joined with a second of the workpieces to be joined at a joint by means of the processing beam producing a weld seam, the capturing of one or more thermal images of a joint portion heated by the processing beam, wherein each of the thermal images comprises a first thermal imaging section, which characterizes the temperature distribution of the first workpiece, and a second thermal imaging section, which characterizes the temperature distribution of the second workpiece, and the evaluation of the thermal images with respect to joining flaws, characterized in that an evaluation of the thermal images is performed with respect to the positioning of the processing beam (7) and the positioning of the processing beam (7) is performed based on the result of the evaluation of the thermal images.

2. Method according to claim 1, characterized in that the processing beam (7) is guided along a processing beam path to the joint (19) and the thermal images are captured by a thermal imaging camera (23), which is arranged such that the observation beam path of the thermal imaging camera at least partially extends along the processing beam path of the processing beam (7).

3. Method according to claim 1, characterized in that the weld seam is a front seam on an overlap joint of two workpieces (3, 5) superposed face-to-face or a flange joint, wherein the workpieces (3, 5) are in the form of sheets.

4. Method according to claim 3, characterized in that each of the thermal images captures the joint portion along the entire width of both front sides of the workpieces (3, 5) arranged mutually contacting at the joint (19).

5. Method according to claim 1, characterized in that from the thermal images at one or more longitudinal positions of the joint (19) a transverse intensity profile (I₃₇), which characterizes the temperature curve along a line (35, 37, 39, 41, 43) extending in a direction transverse to the joint (19), is detected and the evaluation of the thermal images is performed with the involvement of the detected transverse intensity profiles (I₃₇).

6. Method according to claim 5, characterized in that in each transverse intensity profile (I₃₇) the mutual outermost positions (S₁, S₂), at which the transverse intensity profile (I₃₇) is below a predetermined threshold value (I_{S}), are assessed as lateral boundary positions that limit the section (29, 31, 33) heated by the processing beam (7) with respect to the direction extending transverse to the joint (19) and the evaluation of the thermal images is performed with the involvement of the detected boundary positions.

7. Method according to claim 6, characterized in that the distance between the mutual boundary positions (S₁, S₂) is detected as a thermal track width (S) and it is assessed as a joining failure and/or as incorrect positioning of the processing beam (7) when the thermal track width (S) is smaller than a predetermined track width minimum value at one or more longitudinal positions of the joint (19).

8. Method according to claim 5, characterized in that in each transverse intensity profile (I₃₇), a position is assessed as an edge position (K) of one of the workpieces (3, 5) to be joined when in this position, the amount of change in the transverse intensity profile (I₃₇) is at least as large as a predetermined minimum change value, and the positioning of the processing beam (7) is performed with the involvement of the edge position (K).

9. Method according to claim 1, characterized in that from the thermal images at one or more transverse positions of the joint (19) a longitudinal intensity profile (I₄₅), which characterizes the temperature curve along a line (45, 47) extending parallel to the joint (19), is detected and the evaluation of the thermal images is performed with the involvement of the detected longitudinal intensity profiles (I₄₅).
